(19) United States
(12) Patent Application Publication
(10) Pub. No.: US 2005/0023793 A1
(43) Pub. Date: Feb. 3, 2005

(54) Pedal scooter

(76) Inventor: Harry Fu, Fremont, CA (US)

Correspondence Address: Harry Fu, 359 Dana Street, Fremont, CA, 94539, US

(21) Appl. No.: 10/900,499

(22) Filed: Jul. 28, 2004

Related U.S. Application Data
(60) Provisional application No. 60/491,662, filed on Aug. 1, 2003.

(51) Int. Cl. B62M 5/00

(52) U.S. Cl. 280/257

(57) ABSTRACT

This is a three wheel, foot-powered scooter with a steering column in front. The two front wheels are the driving wheels. Each is driven separately by a foot pedal via a speed-increase gear set. The rear wheel is the steering wheel, which is manipulated by the steering column via a mechanical linkage.

### CROSS-REFERENCE TO RELATED APPLICATION

This application is entitled to the benefits of Provisional Patent Application No. 60/491,662, Pedal Scooter, filed on the First of August, 2003.

### DESCRIPTION

1. Field of the Invention

This invention relates to man-powered scooters, more particularly, to foot-powered scooters driven by rider's pedaling.

2. The Prior Art

Foot powered scooters are widely used as a toy or a personal short distance transportation tool. The most basic format has two or three wheels, moved when the rider pushes one foot against the ground. This simple model therefore is slow, inefficient, and uncomfortable. Many inventions have been dedicated to self-propelled scooters, which can eliminate the need of direct contact between the user's feet and the ground. Some of those invented scooters are propelled by means of pedals on the scooter chassis.

Spring drive scooter (U.S. Pat. No. 4,846,488) has two pedals arranged side by side. The pedal mechanism pulls a chain, which drives an axle, and that axle drives a second chain with an increased speed.

Pedal-operated scooter in U.S. Pat. No. 5,192,089 uses one seesaw-type pedal. So, the rider needs to stand his feet along the longitudinal line of scooter chassis. Its two chains are pulled directly by the pedal, each to drive a sprocket. To achieve acceptable speed, it must use a long pedal and a large wheel. Another propelling scooter (U.S. Pat. No. 6,419,251) can be seen as the improvement of the above. It uses two sprockets and three chains. The third chain helps in increasing the vehicle speed.

The driving mechanism in U.S. Pat. No. 6,270,102 uses two sprockets and a loop chain to drive the wheel. A drive link extending from the pedals to an eccentric mounting pin on the first sprocket drives it forward. Still the rider places his feet on the front-rear line of symmetry.

Propelling scooter (U.S. Pat. No. 6,308,244) is the same in overall scheme but uses a gear transmission instead of sprockets and chains. A one-way mechanism enclosed in the transmission converts the pedaling to one-way rotation.

There are three common problems for chain driven mechanism: 1, it is open, posing potential dangers to the rider; 2, it occupies a great deal of space; and 3, it becomes complex when high wheel rotation speed is desired. Therefore, it is difficult to make clean, sleek-looking scooters by using chains.

The pedal arrangement, or where the rider stands his feet, is another issue. A front-rear arrangement is not comfortable for a rider facing forward. On the other hand, side-by-side arrangement creates imbalance problem for two-wheel scheme. When pressing down on the pedal, rider moves his or her weight onto one foot, which is offset from the longitudinal line of symmetry. This imbalance must be compensated by steering or side tilting the vehicle, which is highly uncomfortable, tiring, and may be even impractical since pedals are normally positioned close to the ground in scooters.

### 3. SUMMARY OF THE INVENTION

This invention is a three wheel, foot-powered scooter. The two front wheels are the driving wheels. Each of the front wheels is driven by a foot pedal via a gearbox which increases angular speed. An overrun device is embedded in the driving chain, allowing the wheel to continually rotate forward while the pedal is in station or in the resuming motion. The rear wheel is a steering wheel, which is manipulated via mechanical linkage by a vertical steering column mounted at the vehicle front.

### 4. THE DRAWINGS

FIG. 1. The scooter overview

FIG. 2. Scooter in folded position

FIG. 3. Driving gear and front wheel

FIG. 4. Steering mechanism
A. Steering cables connection
B. Rear wheel and its axle

### 5. DETAIL DESCRIPTION

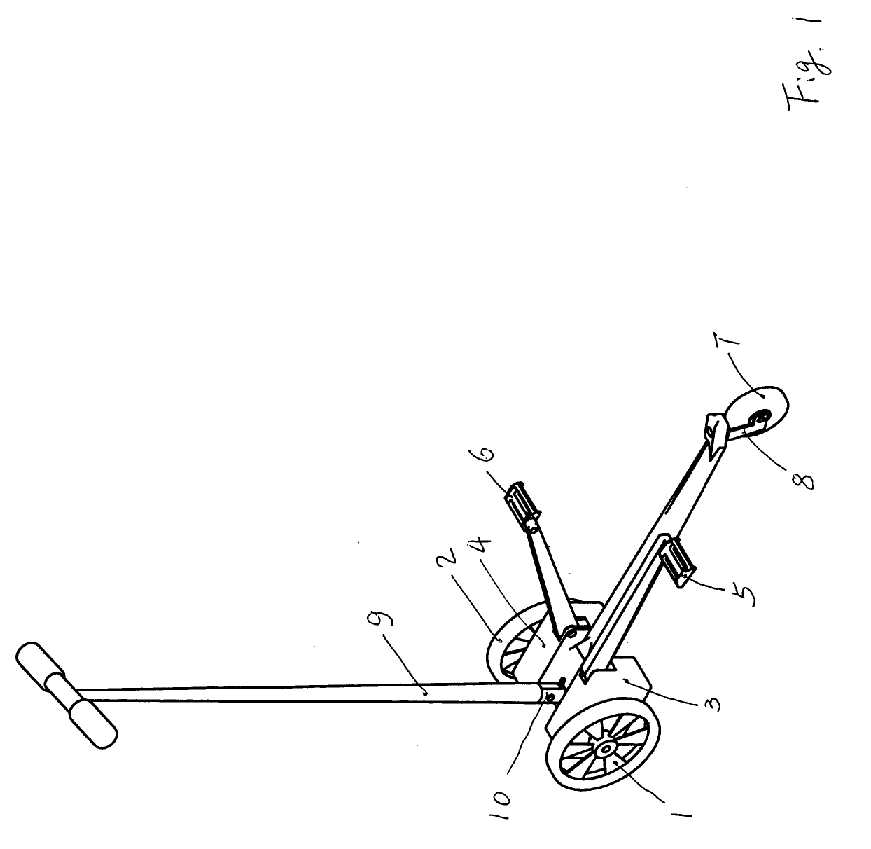

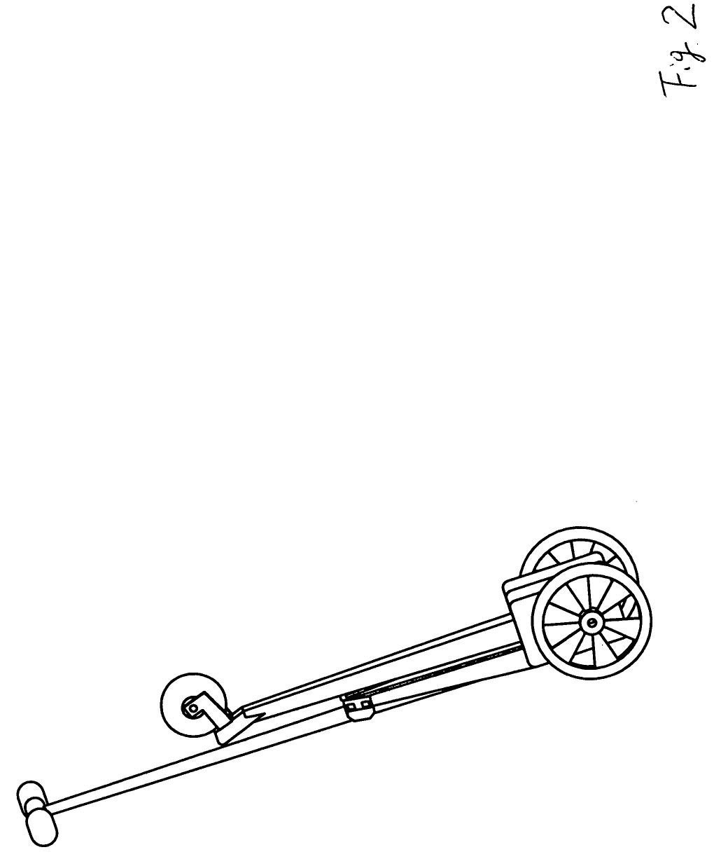

Shown by FIG. 1, the pedal scooter is in a three-wheel scheme. The two front wheels 1, 2 are driving wheels, each is connected to its respective gear box 3 or 4. Each gearbox is powered by one of the two pedals 5 or 6. Rear wheel 7 is a freely running wheel. Its axle, 8, is steerable. In the front, handle column 9 links to steering axle 10, and stands vertically when the scooter is being ridden.

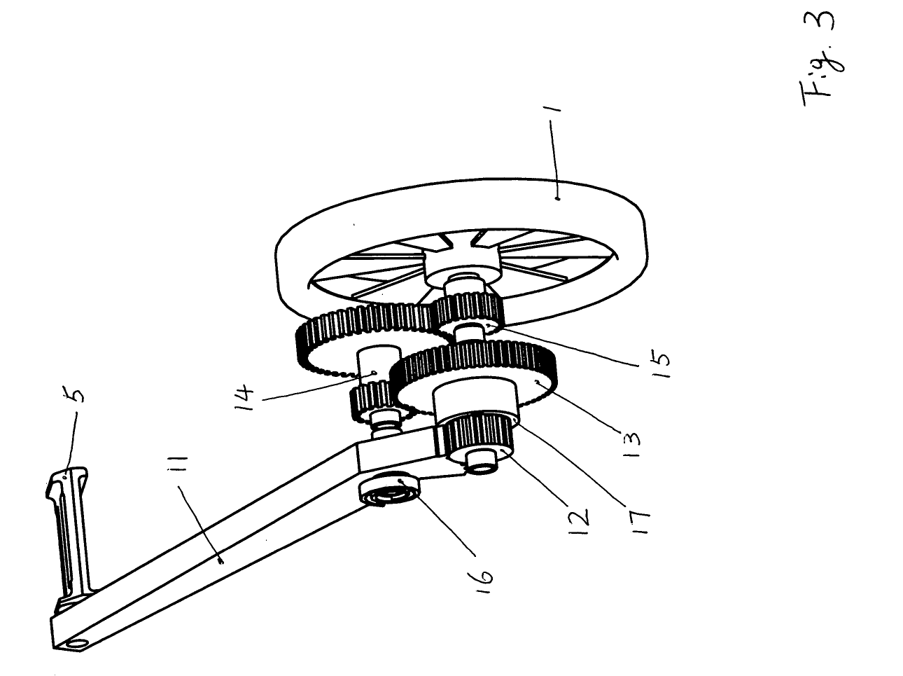

Handle column 9 can be folded down when the scooter is in storage or is being transported. FIG. 2 shows the folding position. In this position, it can be pulled like a luggage cart on its front wheels.

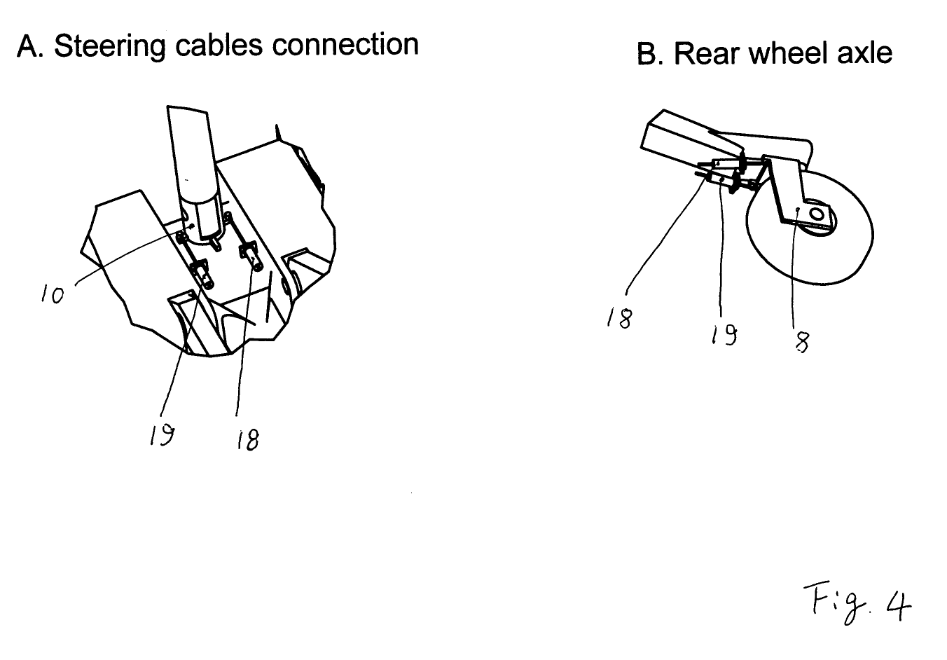

FIG. 3 shows a possible arrangement of the driving gears. When pedal 5 is pushed down, lever 11 rotates. The other end of the lever is shaped in a partial gear, which engages gear 12. Gear 13 on the same axle drives the smaller gear on axle 14. The larger gear on that axle then drives gear 15, which turns the wheel forward. Spring 16 produces a resuming torque on lever 11, which will turn the lever back when pushing force is not being applied on the pedal. Gear 12 and gear 13 are connected via a one-way mechanism 17, such as a roller clutch. In this figure, the clutch is embedded in gear 13. It allows the wheel to keep rolling forward while the pedal is returning to its higher position. Notice, this is only one realization of the basic design. The driving gears can be in different schemes.

FIG. 4 show the rear wheel turning mechanism. There are two cables, 18 and 19, linked to the rear axle 8 (FIG. 4B). The other ends of the cables are linked to pins on the two sides of steering axle 10 (FIG. 4A). The two cables are cross arranged, i.e. the left side of axle 10 links to the right side of axle 8. When rider turns the handle column, axle 10 turns and will pull one cable and slacken the other. The cables then pull the rear axle and turn it to the direction opposite to that of the steering handle. Therefore, the scooter will turn to the way the rider desires. The links can be performed by a single cable arranged in the shape of “8”. In that case, 18, 19 can be the two section of that long cable. In this figure, the axle is backward inclined and the wheel is installed with an offset. This helps maintaining the rear wheel to stay in line when the handle column is not being turned.

1. A three-wheel scooter in the scheme of two front wheels as driving wheels and a rear wheel as steering wheel, of which
a. A beam links the so said front wheels and rear wheel, and
b. A steering column is mounted at the front of the so said beam, and
c. Each so said driving wheel is connected to a gearbox, which converts the up-down movement of a pedal to forward rolling of the wheel, and
d. That the rear wheel is manipulated by turning or side tilting the so said steering column.

2. The scooter as claim 1, of which the steering column can be folded parallel, or nearly so, to the so said beam.

3. The scooter as claim 1, on which a braking device is applied on the so said rear wheel.
